(19) United States
(12) Patent Application Publication
(10) Pub. No.: US 2008/0136637 A1
(43) Pub. Date: Jun. 12, 2008

(54) Low latency listen before talk triggers

(76) Inventor: Rish T. Mehta, Castro Valley, CA (US)

Correspondence Address: INTEL CORPORATION;c/o INTELLEVATE, LLC, P.O. BOX 52050, MINNEAPOLIS, MN, 55402, US

(21) Appl. No.: 11/635,428

(22) Filed: Dec. 6, 2006

(51) Int. Cl. G08B 13/14

(52) U.S. Cl. 340/572.1

(57) ABSTRACT

According to some embodiments of the present invention, a transmission is preconfigured to transmit on a radio channel. The transmitting is delayed until receipt of a trigger from an external source indicating that the radio channel is available.

### BACKGROUND

### Description of the Related Art

This application relates generally to wireless systems.

In one wireless system, a radio frequency identification (RFID) reader/writer communicates with an RFID tag. The RFID tag may be an integrated circuit with a tag insert or inlay including an integrated circuit attached to an antenna. The RFID reader may be a fixed antenna or a portable device such as a barcode scanner.

RFID systems may be utilized to determine the current location of articles of interest. A conventional RFID application is a dock door device in a warehouse. It determines which components with RFID tags on them pass through a loading dock door. Many other applications may also be envisioned including electronic toll collection, sensor applications, inventory control and tracking, asset tracking and recovery, tracking manufacturing parts, tracking goods in supply chains, and payment systems, to mention a few examples.

Listen-before-talk (LBT) transmission requirements specify that wireless systems must listen to determine if another device is transmitting prior to commencing transmission. Each radio waits until there is no other transmission in progress on a channel before beginning to transmit on that channel. Additional LBT provisions reduce the probability that more than one radio will attempt to transmit at the same moment. For example, the LBT requirements include a maximum amount of time between sensing that the medium is free and commencing transmission.

LBT requirements, while non-trivial for most applications, are especially difficult for low-cost RFID applications. Most RFID readers transmit at high levels while having fairly insensitive receivers. At the low LBT signal intensity threshold, the RFID transmission may be sensed over large geographic areas. However, the RFID receiver may only be able to sense transmissions in a small geographic area.

Thus, there is a need for better ways to provide wireless receivers and transceivers to meet LBT transmission requirements, including those used in RFID systems.

### DESCRIPTION OF THE DRAWINGS

The present invention may be better understood, and its numerous features and advantages made apparent to those skilled in the art by referencing the accompanying drawings.

FIG. 1 illustrates a listen-before-talk (LBT) sensor system according to an embodiment of the present invention.

FIG. 2 illustrates a radio transmitter implementation according to an embodiment of the present invention.

FIG. 3 illustrates an LBT sensor implementation according to an embodiment of the present invention.

FIG. 4 illustrates a flow diagram according to an embodiment of the present invention.

The use of the same reference symbols in different drawings indicates similar or identical items.

### DESCRIPTION OF THE EMBODIMENT(S)

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing,” “computing,” “calculating,” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data from registers and/or memory to transform that electronic data into other electronic data that may be stored in registers and/or memory. A “computing platform” may comprise one or more processors.

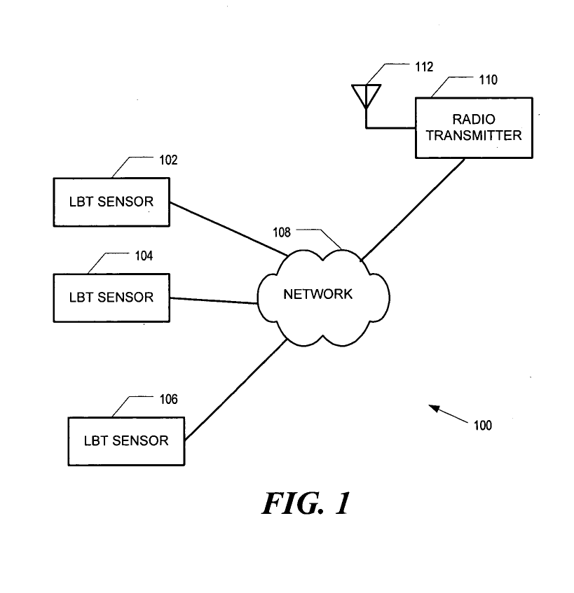

FIG. 1 illustrates a listen-before-talk (LBT) sensor system according to an embodiment of the present invention. System 100 includes multiple LBT sensors 102-106, each connected to a network 108. A radio transmitter 110 with antenna 112 is also connected to network 108. System 100 may support an RFID system, or any other wireless communication system. Network 108 may be an Ethernet network, or other such wired or wireless communication medium. System 100 may include any number of LBT sensors from only one to many. System 100 may include any number of radio transmitters 110. Further, radio transmitter 110 may include an LBT sensor which results may be communicated to other radio transmitters (not shown) through network 108.

Multiple LBT sensors 102-106 may be used to provide large geographic listening capability. Multiple LBT sensors 102-106 may be geographically spaced, fixed or non-fixed in place, for example, in a warehouse. LBT sensors 102-106 determine whether other nearby radios are communicating on a specified radio channel by sensing signal levels above a specified threshold, for example above −96 dBm. LBT sensors 102-106 communicate sensing results to radio transmitter 110 via network 108. If no signals above the threshold are detected on a channel, radio transmitter 110 may begin transmitting on that channel. If signals are detected on the channel, LBT sensors 102-106 may switch to a different channel and listen for signals on the new channel.

LBT sensors 102-106 may communicate simple information, such as OK to transmit or NOT OK to transmit. LBT sensors 102-106 may communicate more complex information, such as signal level detected, new channel information, and the like.

LBT requirements specify that radio transmitter 110 must begin transmitting within a specified time frame, for example, 1 mS, after a clear channel is detected. Because sending sensing information from LBT sensors 102-106 through network 108 to radio transmitter 110 may take a significant amount of time, radio transmitter 110 may be pre-configured and ready to transmit on a specified channel immediately upon receiving an OK to transmit indication. Upon receiving a NOT OK to transmit indication, radio 110 may be re-pre-configured to transmit on a different channel.

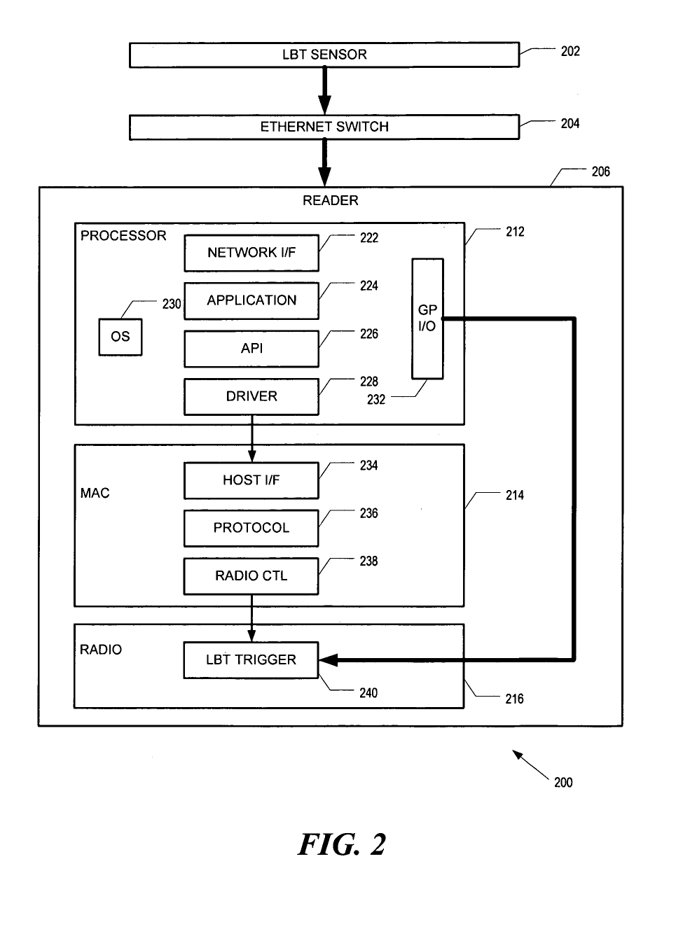

FIG. 2 illustrates a radio transmitter implementation according to an embodiment of the present invention. LBT sensor 202 monitors a wireless medium and communicates status through Ethernet switch 204 to reader 206.

In order to meet LBT requirements, reader 206 is prepared to transmit immediately upon receiving a wireless medium available indication from LBT sensor 202. Further, the indication from LBT sensor 202 bypasses much of the standard processing paths in reader 206 and is immediately communicated to a radio portion 212 of reader 206.

Reader 206 includes processor circuitry 212, media access control (MAC) circuitry 214, and radio circuitry 216. Processor circuitry 212 determines and prepares information to be transmitted. Processor circuitry 212 includes a network interface 222, application layer 224, application programming interface 226, driver 228, operating system 230 and general purpose inputs/outputs 232. MAC circuitry 214 formats the information, for example, according to standardized MAC protocols. MAC circuitry 214 includes host interface 234, protocol layer 236, and radio control 238. Radio 216 converts the formatted information into radio frequency (RF) information. Radio circuitry 216 includes LBT trigger processing circuitry 240. Radio 216 transmits the RF information upon receiving a trigger or an OK to transmit indication.

The time from LBT sensor 202 sensing the medium to reader 206 commencing transmission is limited, for example, the time may be less that 1 mS. This allotted time includes travel time of the trigger from sensor 202 (and possibly other triggers) through the network, that is, Ethernet switch 204, to reader 206. Processing time to configure a transmission by processor 212, MAC circuitry 214 and radio circuitry 216 is also significant. For example, processor 212 may be running a non-real-time operating system 230 (WinXP, WinCE, Linux, and the like). By pre-configuring the transmission such that minimal processing is required upon receipt of the transmit trigger, long latency processes are significantly reduced or eliminated. Further, any processing of the trigger itself is reduced by sending the indication directly to LBT processing circuitry 240. The processor has configured the GPIO to either trigger or be triggered by the LBT signal from the radio block 240. This could take the form of an interrupt to allow the quickest possible reaction time.

Upon receiving an OK to transmit indication, radio 216 may immediately begin transmitting, because a transmission has already been prepared by processor 212, MAC circuitry 214, and radio 216 in anticipation of this trigger. If a NOT OK to transmit indication is received, the transmission by be reconfigured for the new channel in preparation for the next trigger.

According to an alternate embodiment, radio 216 may include an LBT sensor (not shown) and may also provide OK or NOT OK to transmit indications to other readers. By using multiple LBT sensors in a system and aggregating the results, better listening capability is achieved with less expensive antenna and receiver circuitry.

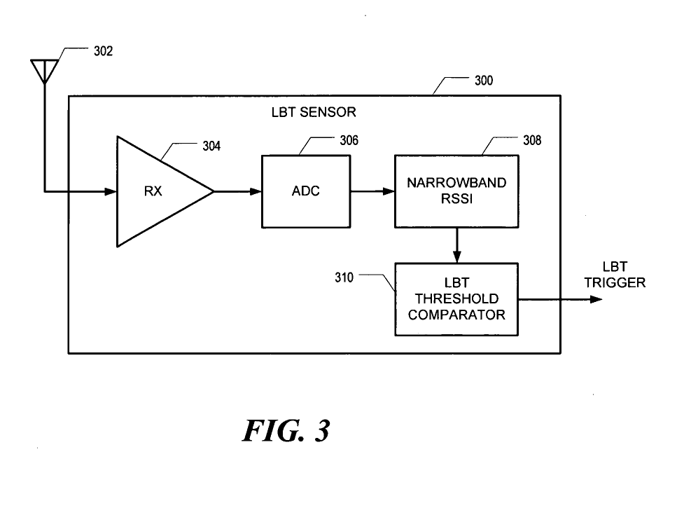

FIG. 3 illustrates an LBT sensor implementation according to an embodiment of the present invention. LBT sensor 300 includes an antenna 302 for listening to the wireless medium to detect availability of the medium, receiver circuitry 304, analog to digital converter (ADC) 306, narrow band receive signal strength indicator (RSSI) 308 and LBT threshold comparator 310. Antenna 302 and receiver 304 sense RF signals on a specified channel. The received signals are converted by ADC 306. The signal strength of the converted signal is determined by narrow band RSSI 308 and compared to the LBT threshold by LBT comparator 310. A trigger signal is generated indicated OK to transmit if no signal above the threshold is detected or NOT OK to transmit if signal(s) above the threshold are detected. The LBT trigger may also include other information, such as a next channel to be scanned.

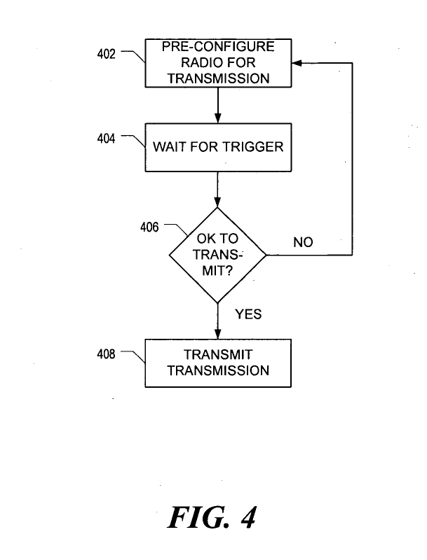

FIG. 4 illustrates a transmission flow diagram according to an embodiment of the present invention. A radio is pre-configured for a transmission, block 402. Further action on the transmission is delayed, waiting for a trigger, block 404. After receipt of the trigger, a determination is made whether it is ok to transmit, block 406. If the trigger indicates that the medium is busy, that is, it is not ok to transmit, the radio may be reconfigured for the transmission on an alternate channel, block 402 or the radio may continue waiting for another trigger, block 404. If the trigger indicates that the medium is available, that is, it is ok to transmit, the radio transmits the transmission, block 408.

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and data transmission media including permanent and intermittent computer networks, point-to-point telecommunication equipment, carrier wave transmission media, the Internet, just to name a few. Other new and various types of computer-readable media may be used to store and/or transmit the software modules discussed herein. Computing systems may be found in many forms including but not limited to mainframes, minicomputers, servers, workstations, personal computers, notepads, personal digital assistants, various wireless devices and embedded systems, just to name a few. A typical computing system includes at least one processing unit, associated memory and a number of input/output (I/O) devices. A computing system processes information according to a program and produces resultant output information via I/O devices.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. A method comprising:
preparing information to be transmitted on a radio channel;
waiting for a trigger from an external source before transmitting the transmission, the trigger indicating an availability of the radio channel;
if the trigger indicates that the radio channel is available, transmitting the information.

2. The method as recited in claim 1, wherein the preparing the information comprises:
determining and processing the information to be transmitted;
formatting the information according to a media access control protocol;
preparing a transceiver to transmit on the radio channel.

3. The method as recited in claim 1, wherein the external source is a listen-before-talk sensor.

4. The method as recited in claim 1, wherein the external source is configured to communicate the trigger though an Ethernet network.

5. The method as recited in claim 1, wherein the external source detects the availability of the radio channel on a different antenna than an antenna used to transmit the information.

6. The method as recited in claim 1, wherein the trigger is an aggregation of multiple triggers from multiple sensors.

7. The method as recited in claim 1, wherein if the trigger indicates that the radio channel is not available, preparing the information for sending on different radio channel.

8. The method as recited in claim 7, wherein the trigger further identifies the different radio channel.

9. The method as recited in claim 1, wherein if the trigger indicates that the radio channel is not available, waiting for another trigger indicating that the radio channel is available.

10. An apparatus comprising:
an external input port;
processing circuitry coupled to the external input port, the processing circuitry to determine and process information to be transmitted on a radio channel prior to receiving an indication of availability of the radio channel;
media access control circuitry to format the information according to a media access control protocol prior to receiving the indication of availability of the radio channel; and
radio circuitry to prepare to send the information on the radio channel prior to receiving the indication of availability of the radio channel; wherein the radio circuitry sends the information on the radio channel upon receipt of a trigger from the external input port, the trigger indicating the availability of the radio channel.

11. The apparatus as recited in claim 10, wherein the trigger is from a listen-before-talk sensor.

12. The apparatus as recited in claim 10, wherein the trigger is from a networked device.

13. The apparatus as recited in claim 10, wherein the trigger is an aggregation of multiple triggers from multiple sensors.

14. The apparatus as recited in claim 10, wherein if the trigger indicates that the radio channel is not available, the processing circuitry and the media access control circuitry is configured to prepare the information for sending on different radio channel.

15. The apparatus as recited in claim 14, wherein the trigger further identifies the different radio channel.

16. The apparatus as recited in claim 10, wherein if the trigger indicates that the radio channel is not available, the radio circuitry is configured to wait for another trigger indicating that the radio channel is available.

17. A system comprising:
an antenna;
an external input port;
processing circuitry coupled to the external input port, the processing circuitry to determine and process information to be transmitted on a radio channel prior to receiving an indication of availability of the radio channel;
media access control circuitry to format the information according to a media access control protocol prior to receiving the indication of availability of the radio channel; and
radio circuitry to prepare to send the information on the radio channel on the antenna prior to receiving the indication of availability of the radio channel;
wherein the indication of availability of the radio channel is received via the external input port, the availability of the radio channel sensed on a different antenna than the antenna used to send the information.

18. The system as recited in claim 17, wherein the indication is from a listen-before-talk sensor.

19. The system as recited in claim 17, wherein the indication is from a networked device.

20. The system as recited in claim 17, wherein the indication is an aggregation of multiple triggers from multiple sensors.

21. The system as recited in claim 17, wherein if the indication indicates that the radio channel is not available, the processing circuitry and the media access control circuitry is configured to prepare the information for sending on different radio channel.

22. The system as recited in claim 21, wherein the indication further identifies the different radio channel.

23. The system as recited in claim 17, wherein if the indication indicates that the radio channel is not available, the radio circuitry is configured to wait for another indication indicating that the radio channel is available.
